(19) United States
(12) Patent Application Publication
(10) Pub. No.: US 2008/0256034 A1
(43) Pub. Date: Oct. 16, 2008

(54) SYSTEM AND METHOD FOR UNDERSTANDING RELATIONSHIPS BETWEEN KEYWORDS AND ADVERTISEMENTS

(76) Inventors: Chi-Chao Chang, Santa Clara, CA (US); Manish Tayal, Santa Clara, CA (US)

Correspondence Address: YAHOO! INC.;C/O DREIER LLP, 499 PARK AVENUE, NEW YORK, NY, 10022, US

(21) Appl. No.: 11/733,630

(22) Filed: Apr. 10, 2007

(51) Int. Cl. G06F 17/30

(52) U.S. Cl. 707/3

(57) ABSTRACT

An impression graph is generated comprising keywords as nodes on a first side of the impression graph and advertisement listing as nodes on a second side of the impression graph, an impression relationship between a given keyword and a given advertisement listing represented by an impression edge connection. A click graph is also generated comprising keywords as nodes on a first side of the click graph and advertisement listing as nodes on a second side of the click graph, a relationship between a given keyword and a given advertisement listing represented by a click edge connection. A mapping function is applied to calculate one or more weights for a given edge in the impression graph and the click graph and the one or more edge weights, the impression graph and the click graph are transformed into a unified bipartite graph.

### CROSS REFERENCE TO RELATED APPLICATIONS

The present application is related to U.S. patent application Ser. No. 11/479,186, entitled “SYSTEM AND METHOD FOR GENERATING FUNCTIONS TO PREDICT THE CLICKABILITY OF ADVERTISEMENTS,” filed on Jun. 29, 2006 and assigned attorney docket no. 7345/30, the disclosure of which is hereby incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The invention relates to understanding the relationship between keywords and advertisements. More particularly, the invention is directed to systems and methods for expanding keyword advertising marketplaces in the context of advertising, search engine result sets comprising sponsored search results, etc.

### BACKGROUND OF THE INVENTION

With the advent of search engines to search the Internet, the use of sponsored search (also referred to as paid search) has increased. Sponsored search is an arrangement whereby companies or individuals pay (e.g., sponsor) for placement of listings of advertisements in a result set that a search engine generates or placement on a page of an affiliate of an advertisement provider, e.g., an advertisement on a blog. Typically, an advertiser places bids for one or more keywords with a term bidding marketplace that works in conjunction with one or more search engines. A given advertiser bids on keywords that indicate an interest in the products, services, information, etc. that they are marketing, as well as a cost that the given advertiser is willing to pay for the placement of the advertisement. Sponsored search has proven to be a sustainable and lucrative business model.

When using a search engine, a user submits a query comprising one or more keywords and the search engine produces a result set comprising one or more listings that fall within the scope of the query, including sponsored search listings. The search engine uses the keywords, as well as other features such as user and advertiser information, to select sponsored search listings for inclusion in the result set. The user generates a lead for the given advertiser that provides the sponsored search listing when he or she selects the sponsored listing, e.g., when the user clicks on an advertisement.

Search engines strive to maintain an increasing supply of users to deliver valuable leads to advertisers and advertisers, in turn, demand a growing supply of leads; resulting in tremendous growth of search engine usage and online advertising budgets. Search engines retain and attract new users by providing relevant web search results and advertising. Advertisers increase demand as lead quality and targeting increase. A marketplace therefore exists that comprises a given keyword, the set of one or more users who provide search queries comprising the keyword over a given period of time (“lead supply”) and advertisers who compete for leads (or clicks) for the given keyword. Search engines or other advertisement providers may use the above-described term bidding marketplace, which is a form of auction, to allocate leads to advertisers.

In a “dense” marketplace, advertiser demand exceeds the supply of leads. The auction is designed such that advertisers who are most relevant to the keyword and value the lead the most place the highest bid on the keyword. In “shallow” or “sparse” marketplaces, advertiser demand is does not exceed the supply of leads. A shallow marketplace has a limited supply of leads because the marketplace is characterized by multiple keyword phrases, as well as keywords that are obscure and often have a very narrow context or intent. Because there are typically a small number of advertisers bidding for these keywords, the average cost per click for a given lead is generally low. Many advertisers bombard search engines with bids for a large number of such keywords to capture opportunities in shallow marketplaces.

Systems and methods are needed to combine dense and shallow marketplaces to aggregate supply and demand, increasing overall relevance to users and competition among advertisers. Therefore, the present invention provides systems and methods that appropriately and efficiently perform these combinations to increase the aggregate value of a sponsored search marketplace to a search engine or other advertisement provider due to a higher supply of users, advertiser demand and price per lead.

### SUMMARY OF THE INVENTION

The present invention is directed towards systems and methods to combine dense and shallow marketplaces to aggregate supply and demand, increasing overall relevance to users and competition among advertisers. A method according to one embodiment is directed towards a method for providing a unified bipartite graph to manage term and marketplace expansion. The method according to this embodiment comprises generating an impression graph comprising keywords as nodes on a first side of the impression graph and advertisement listing as nodes on a second side of the impression graph, an impression relationship between a given keyword and a given advertisement listing represented by an impression edge connection. The method further includes generating a click graph comprising keywords as nodes on a first side of the click graph and advertisement listing as nodes on a second side of the click graph, a relationship between a given keyword and a given advertisement listing represented by a click edge connection. A mapping function is applied to the click graph and the impression graph to calculate one or more weights for a given edge in the impression graph and the click graph and the one or more edge weights, the impression graph and the click graph are transformed into a unified bipartite graph. Sponsored search logs may be utilized as source data for generation of the impression graph and generation of the click graph.

According to one embodiment, generating the click graph comprising identifying a subset of the impression graph. The method may also comprise generating a visual representation of the unified bipartite graph. The visual representation of the bipartite graph may take a number of forms. For example, a given edge representative of a click may be represented as a solid line, whereas a given edge representative of an impression may be represented as a dashed line.

According to one embodiment, applying the mapping function comprises mapping event context information into positive real numbers that represent one or more aspects of the strength of a given edge. Applying the mapping function may comprise instantiating an edge weight vector and may also comprise applying to an event context that describes a given keyword-advertisement listing relationship. Furthermore, the unified bipartite graph (based on the click graph, impression graph and edge weights, may be represented as a three dimensional matrix.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram illustrating a system for determining keyword recommendations for a given keyword or marketplace, also referred to as term or marketplace expansion, according to one embodiment of the present invention;

FIG. 2 is a flow diagram illustrating a process for determining an absolute value measure for a given node in the graph according to one embodiment of the present invention;

FIG. 3 is a flow diagram illustrating a process for determining a conditional value measure for a given node in the graph according to one embodiment of the present invention;

FIG. 4 is a flow diagram illustrating a process for generating a keyword recommendation for a given input keyword according to one embodiment of the present invention; and

FIG. 5 is a flow diagram illustrating a process for generating a keyword recommendation for a given input marketplace according to one embodiment of the present invention.

### DETAILED DESCRIPTION OF THE PREFERRED EMBODIMENTS

In the following description of the preferred embodiments, reference is made to the accompanying drawings that form a part hereof, and in which is shown by way of illustration a specific embodiment in which the invention may be practiced. It is to be understood that other embodiments may be utilized and structural changes may be made without departing from the scope of the present invention.

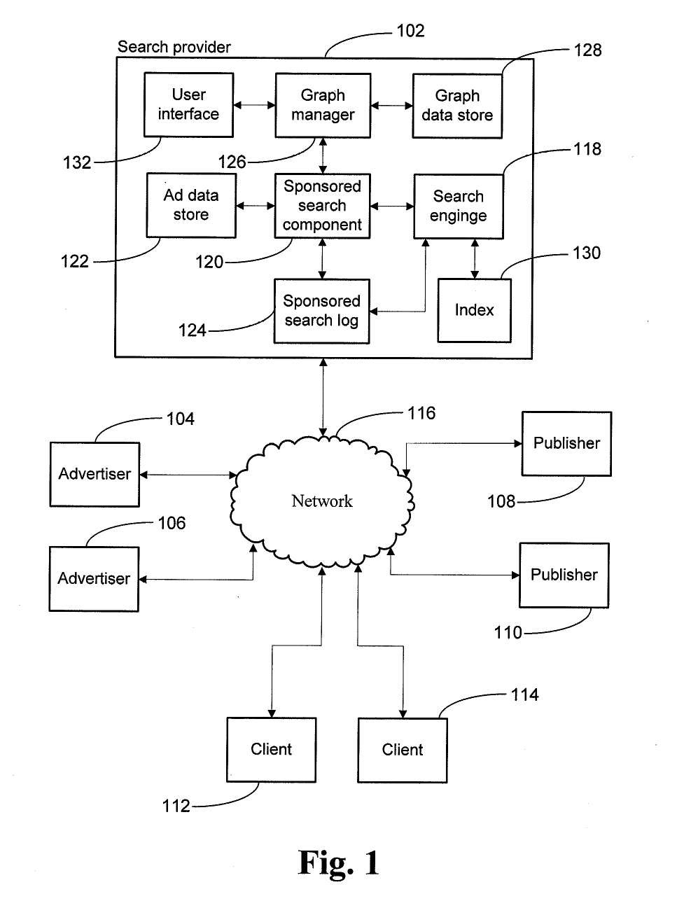

FIG. 1 presents a block diagram illustrating one embodiment of a system for term and term marketplace expansion. The system of FIG. 1 comprises a search provider 102, one or more advertisers 104 and 106 and one or more client devices 112 and 114. The system may further comprise one or more publishers 110. The search provider 102, advertisers 104 and 106, clients 108 and 110 may be in communication over a network 116. Similarly, one or more publishers 108 and 110 may be in communication with other components of the present system over the network 116. The network 116 may comprise one or more interconnected local or wide area networks and may comprise various combinations of wired and wireless transmission mediums, e.g., the Internet.

One or more client devices 112 and 114 may be in communication with the network 116. A given client 112 and 114 may be communicatively coupled to the network 116 to transmit data over the network 116 and process information that the given client 112 and 114 receives over the network 106. According to one embodiment, a given client device 112 and 114 is a general purpose personal computer comprising a processor, transient and persistent storage devices, input/output subsystem and bus to provide a communications path between components comprising the general purpose personal computer. For example, a 3.5 GHz Pentium 4 personal computer with 512 MB of RAM, 40 GB of hard drive storage space and an Ethernet interface to a network. Other client devices are considered to fall within the scope of the present invention including, but not limited to, hand held devices, set top terminals, mobile handsets, PDAs, etc.

A search provider 102 may comprise one or more components including, but not limited to, a search engine 118, a sponsored search component 120, an advertisement data store 122, a sponsored search log 124, a graph manager 126 and a graph data store 128. Advertisers 104 and 106 are in communication over the network 116 with the sponsored search component 120 of the search provider 102. Advertisers 104 and 106 may provide advertisements to the sponsored search component 120 for storage in the advertisement data store 122. In conjunction with a given advertisement (also referred to herein as a “listing”), an advertiser 104 and 106 provides one or more keywords with which the advertisement is associated, a bid and other data regarding the advertisement or advertiser 104 and 106.

The sponsored search component 120 may store these data in the advertisement data store 122, which may be a persistent data store operative to maintain the advertisement and advertiser data the sponsored search component 120 receives. The advertisement data store 122 may be implemented as a flat file data structure (such as a tab or comma separated value file), a relational database, an object-oriented database, a hybrid object-relational database, etc. According to one embodiment, the advertisement data store 122 maintains advertisements and other data in accordance with data structures described in U.S. application Ser. No. 11/324,129, entitled “SYSTEM AND METHOD FOR ADVERTISEMENT MANAGEMENT,” filed on Dec. 30, 2005 and assigned attorney docket no. 7345/9, the disclosure of which is hereby incorporated by reference herein in its entirety.

In addition to passing advertisements and other data to the advertisement data store 122 for storage, the sponsored search component 120 may be operative to calculate a clickability score for a given advertisement in the advertisement data store 122. According to one embodiment, the clickability score represents a probability of an advertisement being selected by a user when the user views the advertisement in response to submission of a query comprising one or more keyword to the search engine 118. Clickability is described in greater detail in commonly-owned U.S. patent Ser. No. 11/479,186, entitled “SYSTEM AND METHOD FOR GENERATING FUNCTIONS TO PREDICT THE CLICKABILITY OF ADVERTISEMENTS,” filed on Jun. 29, 2006 and assigned attorney docket no. 7345/30, the disclosure of which is hereby incorporated by reference herein in its entirety. The sponsored search component 120 may write the clickability score for a given advertisement to the advertisement data store 122.

A user of a given client device 112 and 114 may be in communication over the network 116 with the search engine at 118 the search provider 102. The through use of a given client device 112 and 114, the user submits one or more search queries to the search engine 118. A query received from a client device 112 and 114 may comprise one or more terms. For example, the query “HDTV widescreen television” contains three terms and may be referred to as a three-term query. Similarly, queries containing only one term are referred to as one-term queries, queries containing two terms are two-term queries, etc. A space or other delimiter character may used to identify the individual terms comprising a given query. Additionally, computer program code or similar logic may be executing at the search engine 118 to cluster terms within a given query into one or more units, e.g., statistically significant phrases.

Clustering of terms to generate one or more units may be accomplished through one or more of the systems and methods described in the following U.S. patent applications, which are incorporated by reference herein in their entirety: U.S. patent application Ser. No. 11/295,166, entitled “SYSTEMS AND METHODS FOR MANAGING AND USING MULTIPLE CONCEPT NETWORKS FOR ASSISTED SEARCH PROCESSING,” filed on Dec. 5, 2005 and assigned attorney docket no. 7346/41US; U.S. patent application Ser. No. 10/797,586, entitled “VECTOR ANALYSIS OF HISTOGRAMS FOR UNITS OF A CONCEPT NETWORK IN SEARCH QUERY PROCESSING,” filed on Mar. 9, 2004 and assigned attorney docket no. 7346/54US; U.S. patent application Ser. No. 10/797,614, entitled “SYSTEMS AND METHODS FOR SEARCH PROCESSING USING SUPERUNITS,” filed on Mar. 9, 2004 and assigned attorney docket no. 7346/56US; and U.S. Pat. No. 7,051,023, entitled “SYSTEMS AND METHODS FOR GENERATING CONCEPT UNITS FROM SEARCH QUERIES,” filed on Nov. 12, 2003 and assigned attorney docket no. 7346-55US.

The search engine 118 receives the query from the client device 112 and 114 and attempts to identify one or more content items that fall within the scope of the query. The search engine 118 may search an index 130 of content items that are available on the network 116. According to one embodiment, the index 130 is a list of word location pairs that, given a keyword, is correlated with one or more content items that comprise the keyword. The index 130 may comprise additional information regarding a given content item that includes, but is not limited to, features of a given content item, title, description, inbound links, outbound links, etc.

The search engine 118 utilizes the data that the index 130 returns regarding one or more content items that are responsive to the query from the client device 112 and 114 to formulate or otherwise generate a result set. Program code or similar logic at the search engine 118 may implement a relevance function, using the result set as input to the relevance function, to order the result set according to relevance of the content items with regard to the query. One exemplary system and method that the search engine may implement to determine a ranking function is described in U.S. patent application Ser. No. 10/424,170, entitled “METHOD AND APPARATUS FOR MACHINE LEARNING A DOCUMENT RELEVANCE FUNCTION,” filed on Apr. 23, 2003 and assigned attorney docket no. 600189.119, the disclosure of which is hereby incorporated by reference herein in its entirety.

The search engine 118 may also pass the query from the client device 112 and 114 to the sponsored search component 120 for the retrieval of one or more sponsored search listings. The sponsored search component 120 retrieves one or more advertisements from the advertisement data store 122 on the basis of the query, the user, features of a given advertisement, etc. According to one embodiment, the sponsored search component 120 implements systems and methods described in the previously incorporated “SYSTEMS AND METHODS FOR ADVERTISEMENT MANAGEMENT” or other applications directed towards the selection of sponsored listings that the present application incorporates by reference in their entirety. The search engine 118 receives one or more sponsored search results that the sponsored search component 120 retrieves from the advertisement data store 122, which the search engine 118 incorporates into the result set. In addition to the foregoing, the sponsored search component 120 may write data regarding the advertisements that it retrieves to a sponsored search log 124, indicating that the advertisement was shown to the user (e.g., an “impression”), which may also be performed by the search engine 118.

The search engine transmits the result set over the network to a given client device 112 and 114. The user at the given client device 112 and 114 may select a given item in the result set, causing the client device to navigate to an address that the given item indicates. The user may also select sponsored search results in the result set, which the sponsored search component 120 may encode as a link to the search provider 102 with a re-direct to the address of the content item that the sponsored search listing describes. Accordingly, when a client device 112 and 114 selects a sponsored search listing, e.g., clicks on an advertisement, the client device 112 and 114 is directed to the search provider, which records the click event in a sponsored search log 124. The sponsored search log 124 may comprise an accessible data store such as a flat file data structure (such as a tab or comma separated value file), a relational database, an object-oriented database, a hybrid object-relational database, etc. The client device 112 and 114 is re-directed to the content item that the user selects.

On the basis of the foregoing, sponsored search events may fall into two categories: impression events and click events. An impression event may be an event whereby a user submits a keyword and an advertiser listing is impressed upon or otherwise shown to the user. A click event may be an event whereby a user submits a keyword, an advertiser listing is impressed upon the user and the user clicks on the listing. In either event, impression or click, a relationship the sponsored search component 120 writes information regarding a relationship between a keyword and a listing to the sponsored search log 124. Given a sponsored search log that the sponsored search component 120 accumulates over several days or weeks, millions of such “keyword-listing” relationships may exist in the sponsored search log 124.

The sponsored search component 120 may write context information regarding a keyword-listing relationship to the sponsored search log 124, which may be referred to as an event context. Event context includes, but is not limited to, information regarding pricing, ranking, matching, user demographics and budgeting, among other items of contextual information. Some other examples include the position of the listing in a ranked list of advertisements, bid price of the advertiser for a given keyword and a timestamp for an event. The sponsored search component 120 may write event information to the sponsored search log 124 at the granularity of each instance of an event occurring between a keyword-listing pair, aggregating over all instances of events for a given keyword-listing pair. Exemplary aggregate event context information that the sponsored search log 124 may maintain includes, but is not limited to, a total number of clicks, a total number of impressions, an average cost per click, an average rank of the listing, etc. According to various embodiments, certain items of event context information may not be fully independent and in some instances may be highly correlated.

In addition to the foregoing, the search provider according to embodiments of the invention comprises a graph manager 126 to manage term and marketplace expansion. As described above, the sponsored search log 124 may maintain one or more keyword-listing relationships. The graph manager 126 may represent these keyword-listing relationships as a graph, which according to one embodiment is a bipartite graph. A bipartite graph representation of the keyword-listing relationships that the sponsored search log 124 maintains may represent keywords as node on a left hand side of the graph and listings as nodes on a right hand side of the graph. The graph manager 126 represents relationships between keywords and listings as edges connection corresponding left side nodes and right side nodes. According to one embodiment, the bipartite graph, G=(V, E), is a set of vertices “V” and edges “E.” The vertices in the bipartite graph may be partitioned into two sets, V={Q, A}, where Q={q₁, q₂, . . . qₘ} is a set of keywords and A={a₁, a₂, . . . aₙ} is a set of listings. According for qᵢError! Objects cannot be created from editing field codes.Q and aⱼ Error! Objects cannot be created from editing field codes.A there is an edge connecting the two if (qᵢ, aⱼ) Error! Objects cannot be created from editing field codes.E.

The graph manager 126 may generate two instances of the graph for storage in a graph data store 128, which according to one embodiment comprises an impression graph and a click graph. The graph manager 126 generates the impression graph using impression information that the sponsored search log 124 maintains, whereas the click graph is built using click information. By construction, the click graph may be a subset of the impression graph as an impression event is a prerequisite for the presence of a click event. Because user feedback triggers a click event, the event reaffirms the quality of a match between a keyword-listing pair and therefore may represent a stronger relationship than an impression event. When visualizing the graph, the graph manager may represent a given edge that is part of the click graph as a solid line and a given edge that is part of the impression graph as a dotted line.

The strength of a given keyword-ling relationship in the graph may vary from edge to edge. According to one embodiment, a click edge may represent a stronger relationship than an impression edge. Alternatively, or in conjunction with the foregoing, the graph manager 126 may calculate or otherwise quantify the strength of a given edge (“edge weight”) using event context information from the sponsored search log 124, which the graph manager 126 may obtain directly or through interfacing with the sponsored search component 120. The graph manager 126 may calculate a given edge weight by applying a mapping function, w, to the event context that describes a given keyword-listing relationship.

The mapping function may map event context information into positive real numbers that represent one or more aspects of the strength of a given edge. In calculating a given edge weight, the graph manager 126 may instantiate an edge weight vector W(qᵢ, aⱼ) having k edge weights for a given edge, (qᵢ, aⱼ)Error! Objects cannot be created from editing field codes.Q, according to Table A:

TABLE A

\vec{W}(qᵢ,aⱼ) = {w₁(qᵢ,aⱼ),w₂(qᵢ,aⱼ),...,wₖ(qᵢ,aⱼ)},(qᵢ,aⱼ) ∈ E
where
w₁(qᵢ,aⱼ) = w₁(I(qᵢ,aⱼ),C(qᵢ,aⱼ),rank(qᵢ,aⱼ)......)
w₂(qᵢ,aⱼ) = w₂(I(qᵢ,aⱼ),C(qᵢ,aⱼ),rank(qᵢ,aⱼ)......)
.........
wₖ(qᵢ,aⱼ) = wₖ(I(qᵢ,aⱼ),C(qᵢ,aⱼ),rank(qᵢ,aⱼ)......)

It should be noted that these edge weights may not be fully orthogonal or independent and that correlations may exist among different edge weights.

Using these edge weights that the graph manager 126 derives from the impression and click graphs, however, the graph manager 126 may transform the two graphs into a unified bipartite graph. Mathematically, this graph may be represented as a three-dimensional matrix, S(i, j, k), according to Table B:

TABLE B
$S ( i , j , k ) = S [ {q}_{i} , {a}_{j} , {w}_{k} ] = \{ \begin{matrix}{w}_{k} ( {q}_{i} , {a}_{j} ) , & if ( {q}_{i} , {a}_{j} ) ∈ E \\ 0 , & otherwise\end{matrix}$

The matrix of Table B may be a highly sparse, diagonal matrix, depending on the nature of the keyword-listing relationships. Those of skill in the art recognize that if only one edge weight is considered, the three-dimensional matrix of Table B become a standard two-dimensional adjacency matrix.

The graph manager 126 may be further operative to calculate the weight of a given edge as a function of two perspectives: an edge quality measure, w₁(qᵢ, aⱼ), and an edge value measure, w₂(qᵢ, aⱼ). The edge quality measure represents the quality of a matching between a given listing a given keyword to which the listing is connected to by an edge in the graph. The edge quality measure is measure of relevance and the graph manager 126 may calculate the edge quality measure through the use of several techniques that include, but are not limited to, editorial judgments, linguistic modeling or user feedback. The following illustrations and examples utilize user feedback in the form of clicks, as they are a high performance and reliable mechanism for measuring quality. Accordingly, for a given keyword-listing pair, the graph manager 126 may calculate a clickability score for the pair, which may represent a likelihood of the listing receiving a click from a user when the sponsored search component 120 includes the listing in a result set in response to receipt of the keyword from a client device 112 and 114. Clickability may be measured as an observed click through rate (“CTR”), a normalized CTR, a machine learned clickability score, a COEC, etc. Table C illustrates the edge quality measure:

TABLE C
$\begin{matrix}{w}_{1} ( {q}_{i} , {a}_{j} ) ≡ Quality ( {q}_{i} , {a}_{j} ) , where ( {q}_{i} , {a}_{j} ) ∈ E \\ = Clickability ( {q}_{i} , {a}_{j} ) , where ( {q}_{i} , {a}_{j} ) ∈ E\end{matrix}$

A value measure for a given edge in the graph builds on the quality measure. In addition to measuring the relevance aspects of a given keyword-listing relationship, the value measure captures monetization aspects of the given relationship. The graph manager 126 may calculate the value measure as a function of the total revenue that the keyword-listing pair generates, which may comprise the product of the clickability score for the pair and an average price per click. Table D illustrates the edge value measure:

TABLE D
$\begin{matrix}{w}_{2} ( {q}_{i} , {a}_{j} ) ≡ Value ( {q}_{i} , {a}_{j} ) , ( {q}_{i} , {a}_{j} ) ∈ E \\ = Clickability ( {q}_{i} , {a}_{j} ) \times Avgppc ( {q}_{i} , {a}_{j} ) , ( {q}_{i} , {a}_{j} ) ∈ E\end{matrix}$

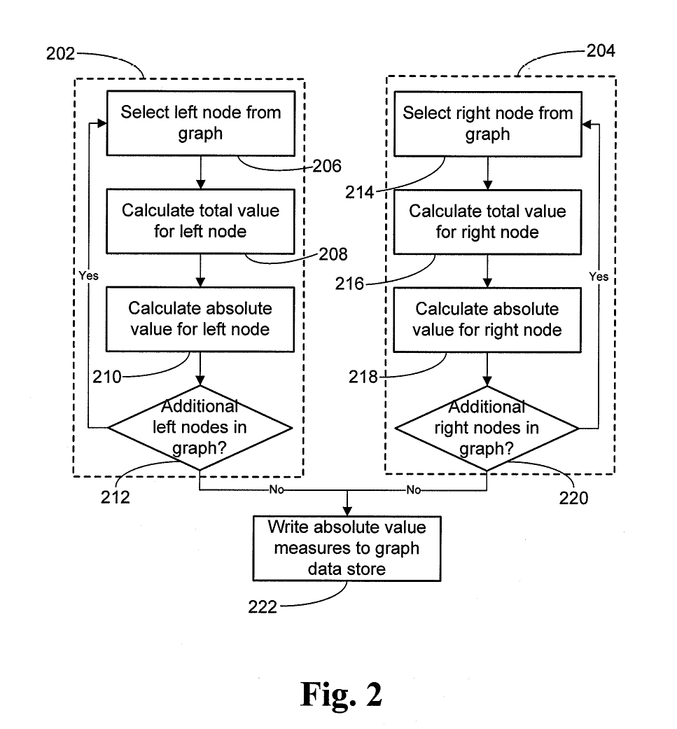

Given the three-dimensional matrix representation of the weighted bipartite graph, S(i, j, k), the graph manager 126 may derive other useful graph metrics including, but not limited to, an absolute value measure and a conditional value measure. For simplicity, and not by way of limitation, only one weight w(qᵢ, aⱼ) represents a given edge weight. FIG. 2 illustrates one embodiment of a process of deriving an absolute value measure from the graph. According to the embodiment that FIG. 2 illustrates, two sub-processes 202 and 204 may be run in parallel, e.g., through the implementation of concurrently executing programming threads, whereby one process 202 calculates an absolute value measure for a left node and the other process 204 calculates an absolute value measure for a right node.

The graph manger selects a first left node, step 206 and a first right node, step 214, from the graph. The graph manager uses a sum of the edge value measures for the first left node to calculate a total value for the first left node, step 208. The graph manager also uses a sum of the edge value measures for the first right node to calculate a total value for the first right node, step 216. According to one embodiment, the total value for a given node is the sum of the edge value measures over the edges to which the given node belongs.

On the basis of the total value measure for the first left node, the graph manager calculates or otherwise determines an absolute value for the first left node, step 210, e.g., an absolute value for a keyword, qᵢ, as Table E illustrates:

TABLE E
$P ( {q}_{i} ) = {\sum }_{∀ {a}_{j}} w ( {q}_{i} , {a}_{j} ) , where ( {q}_{i} , {a}_{j} ) ∈ E$

The graph manager also calculates or otherwise determines an absolute value for the first right node, step 218, e.g., an absolute value for a listing, aj, as Table F illustrates:

TABLE F
$P ( {a}_{j} ) = {\sum }_{∀ {q}_{i}} w ( {q}_{i} , {a}_{j} ) , where ( {q}_{i} , {a}_{j} ) ∈ E$

A check is made to determine if there are additional left nodes in the graph that require processing, step 212. Similarly, a check determines if there are additional right nodes in the graph that require processing, step 220. Where either check evaluates to true, the given sub-routine executes, e.g., program flow returns to steps 206 or 214 on the basis of checks at steps 212 and 220, respectively, and a subsequent left node may be selected, a subsequent right node may be selected, or both. Where either check evaluates to false, the graph manager writes the absolute value measures to the graph data store, step 222

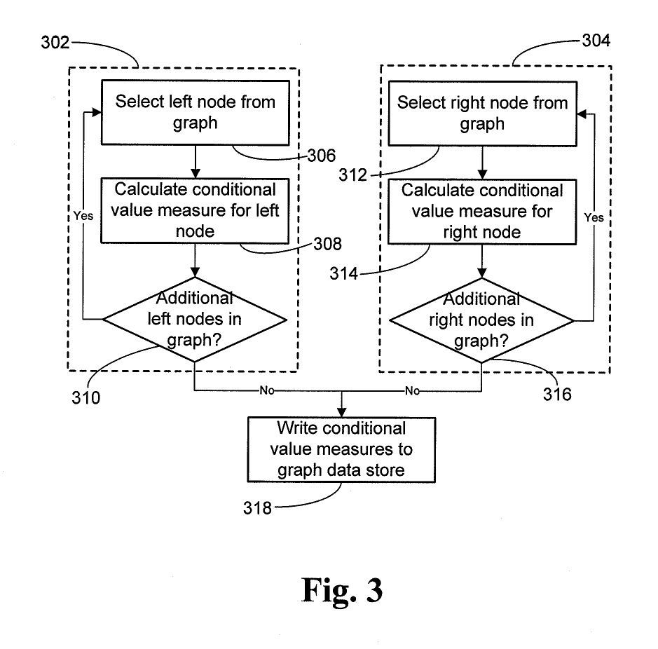

Another useful metric that the graph exposes is a conditional value measure. FIG. 3 illustrates one embodiment of a method for determining a conditional value measure. According to the embodiment that FIG. 3 illustrates, two sub-processes 302 and 304 may be run in parallel, e.g., through the implementation of concurrently executing programming threads, whereby one process 302 calculates a conditional value measure for a first left node and the other process 304 calculates a conditional value measure for a first right node. The conditional value measure may indicate a likelihood that an edge exists between a given left node and a given right node (and vice versa).

The process begins with the selection of a first left node and the selection of a first right node, steps 306 and 312, respectively. The graph manager calculates or otherwise determines a conditional value for the first left node, step 308, e.g., a conditional value for a keyword, qᵢ, as Table G illustrates:

TABLE G
$P ( {a}_{j} \vert {q}_{i} ) = \frac{P ( {a}_{j} ⋂ {q}_{i} )}{P ( {a}_{j} )} = \frac{w ( {q}_{i} , {a}_{j} )}{{\sum }_{∀ {q}_{i}} w ( {q}_{i} , {a}_{j} )} , where ( {q}_{i} , {a}_{j} ) ∈ E$

The graph manager also calculates or otherwise determines a conditional value for the first right node, step 314, e.g., a conditional value for a listing, aⱼ, as Table H illustrates:

TABLE H
$P ( {q}_{i} \vert {a}_{j} ) = \frac{P ( {q}_{i} ⋂ {a}_{j} )}{P ( {q}_{i} )} = \frac{w ( {q}_{i} , {a}_{j} )}{{\sum }_{∀ {a}_{j}} w ( {q}_{i} , {a}_{j} )} , where ( {q}_{i} , {a}_{j} ) ∈ E$

According to the present embodiment, it should be noted that P(qᵢ|aⱼ) is not the same as P(aⱼ|qᵢ), as the former is relative to aⱼ and the latter is relative to qᵢ.

A check is made to determine if there are additional left nodes in the graph that require processing, step 310. Similarly, a check determines if there are additional right nodes in the graph that require processing, step 316. Where either check evaluates to true, the given sub-routine executes, e.g., program flow returns to steps 306 or 312 on the basis of checks at steps 310 and 316, respectively. A subsequent left node may be selected, a subsequent right node may be selected, or both. Where either check evaluates to false, the graph manager writes the conditional value measures to the graph data store, step 318

Returning to FIG. 1, the graph manager 126 stores the weighted bipartite graph that it generates, as well as metrics regarding the graph, on a graph data store 128. The graph data store 128 is an accessible memory structure that may comprise a flat file data structure (such as a tab or comma separated value file), a relational database, an object-oriented database, a hybrid object-relational database, etc. The graph manager 126 may mine the bipartite graph that the graph data store 128 maintains to discover related, relevant and valued keywords and marketplaces. Accordingly, the graph manager 126 is operative to implement methods described in greater detail herein to determine one or more keyword or marketplace recommendations for presentation to an advertiser via the network 116 through the use of a user interface 132, which may be a graphical user interface.

The graph manager 126 is operative generate a set of p-query recommendations for a given keyword or marketplace, providing for keyword or marketplace expansion. Given an initial keyword, q₀, as an input, the graph manager 126 may output a ranked list of keyword recommendations {q₁, q₂. . . , qₚ}. The graph manager 126 may also receive a given marketplace comprising a set of one or more keywords as an input and output a ranked list of keyword recommendations for the given marketplace.

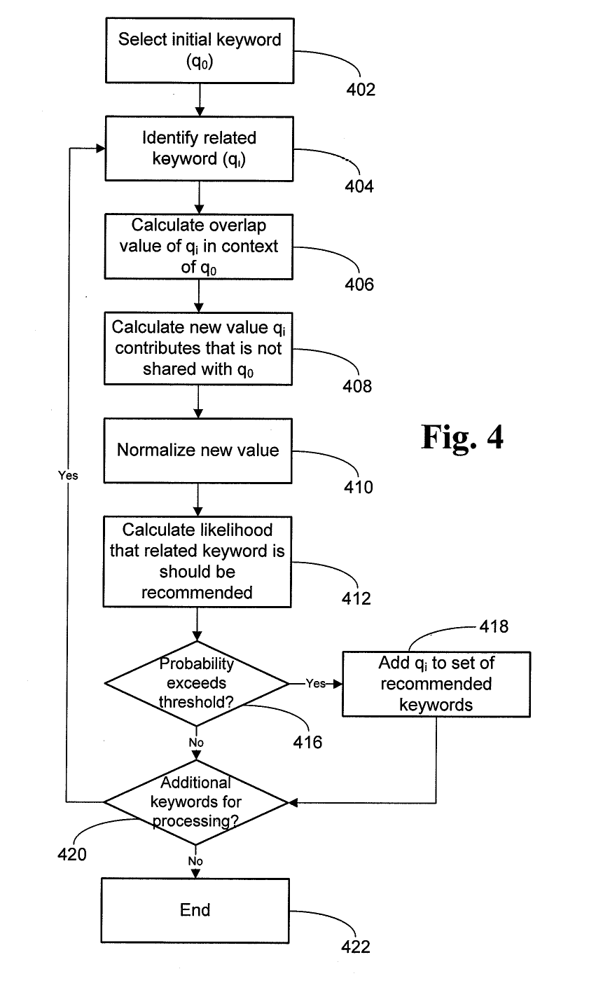

In a bipartite graph, direct edges do not exist that connect any two left nodes (or any two right nodes) in the graph. Closely related keywords (represented as left nodes), however, are indirectly connected via edges with common listing (represented as right nodes). From a given keyword node, the graph manager 126 may traverse the graph to reach common listings. Furthermore, from common listings the graph manager 126 may reach and identify other closely related keywords. FIG. 4 presents a flow diagram illustrating one embodiment of a process for generating a keyword recommendation for a given input keyword.

According to the flow diagram of FIG. 4, the process begins with the selection of an initial keyword for expansion, q₀, step 402. The process continues with the selection of a keyword for potential recommendation, qᵢ, step 404. The total vale of qᵢ is split into two portions in the context of q₀: an overlap value and a new value. The overlap value, which according to one embodiment is a measure of a common value that the two keywords share, is calculated, step 406. The overlap value may also be thought of as a measure of association or affinity between two keywords. According to one embodiment, the overlap value is equal to the number of listings between the two keywords that overlap. Alternatively, from a value perspective, the overlap value may be measured as the total value of qᵢ that is shared with that of q₀ through common listings, as Table I illustrates:

TABLE I
$OV ( {q}_{i} \vert {q}_{0} ) = {\sum }_{∀ {a}_{j}} Value ( {q}_{i} , {a}_{j} ) , where ( {q}_{0} , {a}_{j} ) ∈ E and ( {q}_{i} , {a}_{j} ) ∈ E$

In addition to an overlap value, the graph manager may also calculate a new value, step 408, which according to one embodiment is a measure of the total value of qᵢ that is not shared with that of q₀. The new value may also be thought of as a measure of new incremental or additional value contributed by qᵢ to the existing value of the initial keyword q₀. According to one embodiment, the new value is a count of the number of listing of qᵢ that are not connected to q₀. Alternatively, from a value perspective, the new value may be measured as the total value of qi that is not shared with that of q0 through common listings, as Table J illustrates:

TABLE J
$NV ( {q}_{i} \vert {q}_{0} ) = {\sum }_{∀ {a}_{j}} Value ( {q}_{i} , {a}_{j} ) , where ( {q}_{0} , {a}_{j} ) ∉ E and ( {q}_{i} , {a}_{j} ) ∈ E$

The graph manager normalizes the overlap value and the new value, step 410. Normalization of the new value may be made appropriately from the perspective of q₀. Table K illustrates two techniques for the normalization of the overlap value for a given pair of keywords:

TABLE K
$OV ( {q}_{i} \vert {q}_{0} ) = \frac{{\sum }_{∀ {a}_{j}} Value ( {q}_{i} , {a}_{j} )}{P ( {q}_{0} )} , where ( {q}_{0} , {a}_{j} ) ∈ E and ( {q}_{i} , {a}_{j} ) ∈ E$
$OV ( {q}_{i} \vert {q}_{0} ) = \frac{2 * {\sum }_{∀ {a}_{j}} Value ( {q}_{i} , {a}_{j} )}{P ( {q}_{i} ) + P ( {q}_{0} )} , where ( {q}_{0} , {a}_{j} ) ∈ E and ( {q}_{i} , {a}_{j} ) ∈ E$

Similarly, Table L presents two techniques for the normalization of the new value for a given pair of keywords:

TABLE L
$NV ( {q}_{i} \vert {q}_{0} ) = \frac{{\sum }_{∀ {a}_{j}} Value ( {q}_{i} , {a}_{j} )}{P ( {q}_{0} )} , where ( {q}_{0} , {a}_{j} ) ∉ E and ( {q}_{i} , {a}_{j} ) ∈ E$
$NV ( {q}_{i} \vert {q}_{0} ) = \frac{2 * {\sum }_{∀ {a}_{j}} Value ( {q}_{i} , {a}_{j} )}{P ( {q}_{i} ) + P ( {q}_{0} )} , where ( {q}_{0} , {a}_{j} ) ∉ E and ( {q}_{i} , {a}_{j} ) ∈ E$

On the basis of the overlap value for the keyword pair and the new value for the keyword pair, step 406 and step 408, which may be a normalized overlap value and a normalized new value, step 410, the graph manager may calculate a likelihood score, P(qᵢ), that qᵢ is an appropriate recommendation for q₀, step 412. The likelihood score may comprise a function of the sum of the overlap and the new score, as Table M illustrates:

TABLE M

P(qᵢ) = f(OV(qᵢ | q₀) + NV(qᵢ | q₀))

The graph manager may perform a check to determine if the probability exceeds a threshold, step 416. If the check evaluates to true, the graph manager writes the keyword qᵢ to a set of recommended keywords for keyword q₀, step 418 Regardless, processing flows to step 420 where a check is performed to determine if an additional keyword, qᵢ′, exists for processing. If true, the graph manager selects an additional keyword for processing, step 404, and the loop repeats. If the check evaluates to false, step 420, the process concludes, step 422.

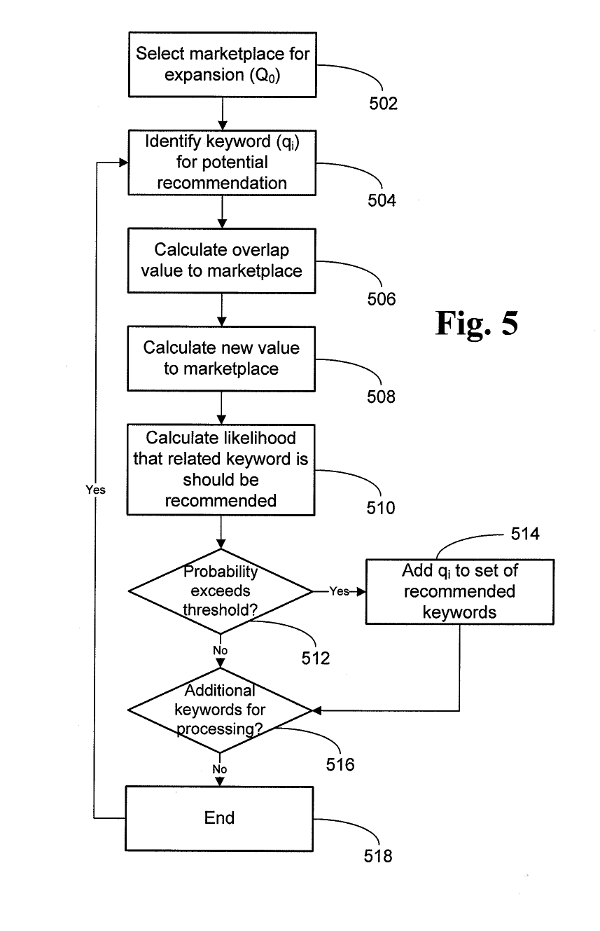

In addition to keyword recommendation on the basis of a given keyword, the present system may provide a keywords recommendation on the basis of a marketplace. FIG. 5 presents a flow diagram illustrating one embodiment of a process for generating a keyword recommendation for a given input marketplace. According to the flow diagram of FIG. 5, the process begins with the selection of an initial marketplace for expansion, Q₀, step 502, and continues with the selection of a keyword for potential recommendation, qᵢ, step 504. According to one embodiment, the initial marketplace is a set of one or more keywords, such that Q₀={q₀₁, q₀₂, . . . , q₀ₘ}.

The graph manager may calculate an overlap value to the marketplace, step 506. The overlap value to the marketplace may be a common value shared between the initial marketplace and the keyword recommendation, and may be broadly thought of a measure of proximity or relevance to the marketplace. The overlap value may be calculated by determining a number of listing of qᵢ that overlap with any keywords in the marketplace. From a value perspective, the overlap value may be measured as the total value of qᵢ that is shared with the marketplace. The overlap value may be normalized as Table N illustrates:

TABLE N
$OV ( {q}_{i} \vert {Q}_{0} ) = {\sum }_{∀ {a}_{j}} Value ( {q}_{i} , {a}_{j} ) , \\ where ( {q}_{i} , {a}_{j} ) ∈ E , ( {q}_{0 l} , {a}_{j} ) ∈ E and {q}_{0 l} ∈ {Q}_{0}$

The graph manager may also calculate a new value to the marketplace, step 508. The new value to the marketplace may be the total value of qᵢ that is not shared with the marketplace. Similarly, the new value may be a measure of new incremental or additional value that qi contributes to the marketplace in the form of new listings and revenue associated with those listings. The new value may be calculated by determining the number of listings of qᵢ that are not connected to any listings of keywords in the marketplace. The graph manager may normalize the new value as Table O illustrates:

TABLE O
$NV ( {q}_{i} \vert {Q}_{0} ) = {\sum }_{∀ {a}_{j}} Value ( {q}_{i} , {a}_{j} ) , \\ where ( {q}_{i} , {a}_{j} ) ∈ E and ( {q}_{0 l} , {a}_{j} ) ∉ E ∀ {q}_{0 l} ∈ {Q}_{0}$

On the basis of the overlap value for the keyword pair and the new value for the keyword pair, step 506 and step 508, the graph manager may calculate a likelihood score, P(qᵢ), that qᵢ is an appropriate recommendation for the marketplace Q₀, step 510. The likelihood score may comprise the sum of the overlap and the new score, as illustrated in Table M. The graph manager may perform a check to determine if the probability exceeds a threshold, step 512. If the check evaluates to true, the graph manager writes the keyword qᵢ to a set of recommended keywords the marketplace Q₀, step 514. Regardless, processing flows to step 516 where a check is performed to determine if an additional keyword, qᵢ′, exists for processing. If true, the graph manager selects an additional keyword for processing, step 504, and the loop repeats. If the check evaluates to false, step 516, the process concludes, step 518.

Returning to FIG. 1, the graph manager 126 may optimize keyword recommendations on the basis of one or more objectives. For example, when the graph manger 126 generates a keyword or marketplace recommendation, certain values are generated for a quality measure, overlap value and new value. Those of skill in the art might recognize that these measures are not purely orthogonal and independent metrics and may therefore only be optimized to a certain degree, beyond which the metrics compete. Accordingly, one embodiment of the present invention contemplates determining a recommendation as a multi-objective optimization problem. According to one embodiment, the multiple objectives are: 1) optimize quality measure of a given recommendation; 2) optimize the value measure of a given recommendation; and 3) optimize a total new value of a set of one or more recommendations to a given keyword or marketplace. Those of skill in the art should recognize that a system administrator or other operator may modify the objective over which the graph manager 126 optimizes the recommendations.

FIGS. 1 through 6 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method for providing a unified bipartite graph to manage term and marketplace expansion, the method comprising:
generating an impression graph comprising keywords as nodes on a first side of the impression graph and advertisement listing as nodes on a second side of the impression graph, an impression relationship between a given keyword and a given advertisement listing represented by an impression edge connection;
generating a click graph comprising keywords as nodes on a first side of the click graph and advertisement listing as nodes on a second side of the click graph, a relationship between a given keyword and a given advertisement listing represented by a click edge connection;
applying a mapping function to calculate one or more weight for a given edge in the impression graph and the click graph;
transforming the one or more edge weights, the impression graph and the click graph into a unified bipartite graph

2. The method of claim 1 comprising utilizing sponsored search logs as source data for generation of the impression graph and generation of the click graph.

3. The method of claim 1 wherein generating the click graph comprises identifying a subset of the impression graph.

4. The method of claim 1 comprising generating a visual representation of the unified bipartite graph.

5. The method of claim 4 wherein generating a visual representation of the unified bipartite graph comprises representing a given edge representative of a click as a solid line.

6. The method of claim 4 wherein generating a visual representation of the unified bipartite graph comprises representing a given edge representative of an impression as a dashed line.

7. The method of claim 1 wherein applying the mapping function comprises mapping event context information into positive real numbers that represent one or more aspects of the strength of a given edge.

8. The method of claim 7 wherein applying the mapping function comprises instantiating an edge weight vector.

9. The method of claim 7 wherein the mapping function comprises applying to an event context that describes a given keyword-advertisement listing relationship.

10. The method of claim 1 wherein the unified bipartite graph is a three dimensional matrix.
